(19) United States
(12) Patent Application Publication
(10) Pub. No.: US 2015/0158708 A1
(43) Pub. Date: Jun. 11, 2015

(54) Canning Jar Band Tool and Method of Assembly of Same

(71) Applicant: Hearthmark, LLC, Daleville, IN (US)

(72) Inventor: Scott Hager, McCordsville, IN (US)

(73) Assignee: Hearthmark, LLC, Daleville, IN (US)

(21) Appl. No.: 14/413,110

(22) PCT Filed: Jul. 9, 2013
(86) PCT No.: PCT/US13/49710

§ 371 Date: Jan. 6, 2015

Related U.S. Application Data
(60) Provisional application No. 61/669,709, filed on Jul. 10, 2012.

(51) Int. Cl. B67B 3/20; B25B 23/142; B25B 13/48; B67B 7/18; B67B 7/14

(52) U.S. Cl. CPC B67B 3/2073; B67B 3/2006; B67B 7/18; B67B 7/14; B25B 13/48; B25B 23/1427

(57) ABSTRACT

A canning jar band tool for facilitating closure of a home canning jar closure system is provided, wherein the home canning jar closure system includes a disk-shaped lid and a separate annular screw-threaded closure band. The canning closure tool includes a head assembly for releasably gripping a closure band. The canning closure tool also includes a handle assembly. A torsion limit assembly couples the head assembly to the handle assembly. The torsion limit assembly is configured to facilitate selective pivoting movement of the handle assembly relative to the head assembly. The head assembly includes a head tool coupled to the handle assembly. The head assembly also includes a split band compression ring pivotably coupled to the head tool for pivoting between a nested position within the head tool and a deployed position for facilitating positioning of the band compression ring frame around a canning jar closure band.

### CROSS-REFERENCE TO RELATED APPLICATIONS

This application claims the priority of U.S. Provisional Application No. 61/669,709, filed Jul. 10, 2012, the complete disclosure of which is hereby incorporated by reference in its entirety.

### BACKGROUND OF THE DISCLOSURE

The present disclosure relates generally to home canning jars and closures for home canning jars that include annular screw-threaded closure bands. More specifically, the present disclosure relates to tools for facilitating application and/or removal of annular screw-threaded closure bands.

In a typical home canning system, a glass jar is provided that includes threaded fittings surrounding the mouth of the jar. To seal the jar, a two-component closure system is used that includes a disk-shaped lid and an annular screw-threaded closure band. First, the lid is fitted onto a lip of the jar. Thereafter, the closure band is fitted over the lid and screwed down onto the jar. For optimal sealing, the closure band should be tightened onto the jar with an amount of torque that is within a predetermined range. If a closure band is not tightened with sufficient torque, the seal may fail. If a closure band is tightened with excessive torque, the closure band and/or the lid may be deformed, likewise resulting in an inadequate seal.

In at least some known home canning systems, individuals that use home canning jars with annular screw-threaded closure bands frequently hand-tighten the closure bands. The practice of hand-tightening closure bands is problematic, in that different individuals possess different degrees of hand and arm strength. Moreover, some individuals, particularly the elderly and the physically-challenged, may have difficulties in exerting sufficient force to adequately tighten the bands. Conversely, some individuals may be capable of exerting more than sufficient force, such that the closure band may be over-tightened.

In at least some known home canning systems, a visual indicator dial system is printed directly on the closure. The visual indicator dial system, sometimes referred to as a “dot-dash” system, includes a plurality of dots printed onto the lid and a plurality of dashes printed onto the band. When the closure band is tightened onto the jar, the dots on the lid are aligned with the dashes on the closure band, to indicate when the closure band has been sufficiently tightened. However, due to variations in closure and/or jar dimensions relating to manufacturing tolerances, the alignment of dots and dashes does not necessarily ensure that the closure band has been tightened onto the jar with a torque level that is within a desired range.

It is desirable to provide a tool for tightening a closure for a home canning system that provides for secure tightening of closure bands within a desired torque range.

### BRIEF DESCRIPTION OF THE DISCLOSURE

In one embodiment, a canning closure tool for facilitating manipulation of a closure for a canning jar is provided, wherein the closure includes a lid and an annular screw-threaded closure band. The canning closure tool includes a head assembly for releasably gripping a closure band. The canning closure tool also includes a handle assembly. The canning closure tool also includes a torsion limit assembly coupling the head assembly to the handle assembly, the torsion limit assembly configured to facilitate selective pivoting movement of the handle assembly relative to the head assembly.

In another embodiment, a canning closure tool for facilitating manipulation of a closure for a canning jar is provided, wherein the closure includes a lid and an annular screw-threaded closure band. The canning closure tool includes a handle assembly. The canning closure tool also includes a head assembly coupled to the handle assembly for releasably gripping a closure band. The head assembly includes a head tool coupled to the handle assembly. The head assembly also includes a split band compression ring pivotably coupled to the head tool for pivoting between a nested position within the head tool and a deployed position for facilitating positioning of the band compression ring frame around a canning jar closure band.

In another embodiment, a method for assembling a canning closure tool for facilitating manipulation of a closure for a canning jar is provided, wherein the closure includes a lid and an annular screw-threaded closure band. The method includes providing a head assembly for releasably gripping a closure band. The method also includes providing a handle assembly. The method also includes coupling the head assembly to the handle assembly with a torsion limit assembly, wherein the torsion limit assembly is configured to facilitate selective pivoting movement of the handle assembly relative to the head assembly.

### BRIEF DESCRIPTION OF THE DRAWINGS

FIGS. 1-17 illustrate example embodiments of the canning jar band tool and methods described herein.

FIG. 1 is a perspective exploded view of an example canning jar band tool according to a first embodiment of the present disclosure.

FIG. 2 is an enlarged top perspective view of the canning jar band tool shown in FIG. 1.

FIG. 3 is an enlarged top perspective view of the canning jar band tool shown in FIG. 1, showing a split band compression ring of a head assembly pivoted into a deployed orientation.

FIG. 4 is a bottom perspective view of the canning jar band tool shown in FIG. 1.

FIG. 5 is a bottom perspective view of the compression ring frame illustrated in FIG. 3, shown without an elastic overmold component of the compression ring frame.

FIG. 6 is a top perspective view of a handle frame of the canning jar band tool shown in FIG. 1.

FIG. 7 is a bottom perspective view of the handle frame shown in FIG. 6.

FIG. 8 is a front perspective view of a handle boot.

FIG. 9 is an enlarged exploded view of the head assembly, illustrating placement of a pivot angle limit insert within a head frame of the head assembly.

FIG. 10 is an enlarged perspective view of the handle assembly shown in FIG. 1, illustrating placement of a coil spring member within the handle frame.

FIG. 11 is an enlarged perspective view of the handle assembly of the canning jar band tool shown in FIG. 1, illustrating placement of the pivot angle limit insert within the handle frame.

FIG. 12 is a top perspective view illustrating a first step in the use of the canning jar band tool of the embodiment of FIGS. 1-11 on a home canning closure system.

FIG. 13 is a top perspective view illustrating a subsequent step in the use of the canning jar band tool shown in FIG. 12.

FIG. 14 is a sectional view of a canning jar band tool in position on a jar, taken along line 14-14 of FIG. 13.

FIG. 15 is an enlarged perspective view of a head frame and handle frame illustrating a pivot angle limit assembly according to an alternative embodiment of the present disclosure.

FIG. 16 is an end perspective view of the handle assembly of the canning jar band tool shown in FIGS. 1-11, illustrating a lid opener assembly.

FIG. 17 is a side elevation of the lid opener assembly illustrated in FIG. 16, wherein the lid opener assembly is shown being applied to a lid.

### DETAILED DESCRIPTION OF THE DISCLOSURE

The following detailed description illustrates the disclosure by way of example and not by way of limitation. The description clearly enables one skilled in the art to make and use the disclosure, describes several embodiments, adaptations, variations, alternative, and use of the disclosure, including what is presently believed to be the best mode of carrying out the disclosure.

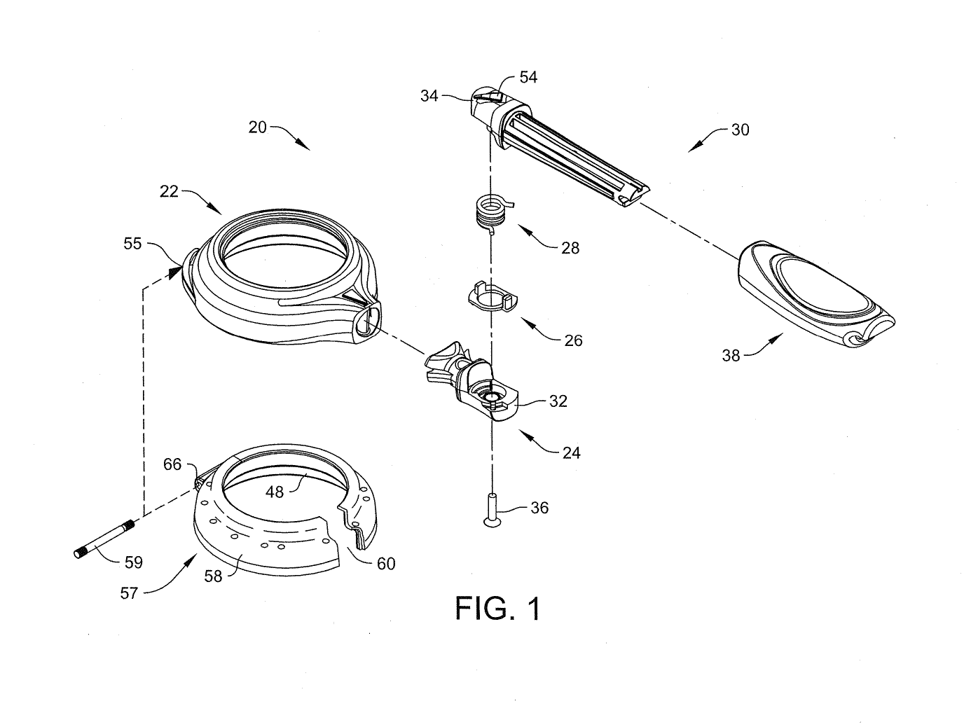

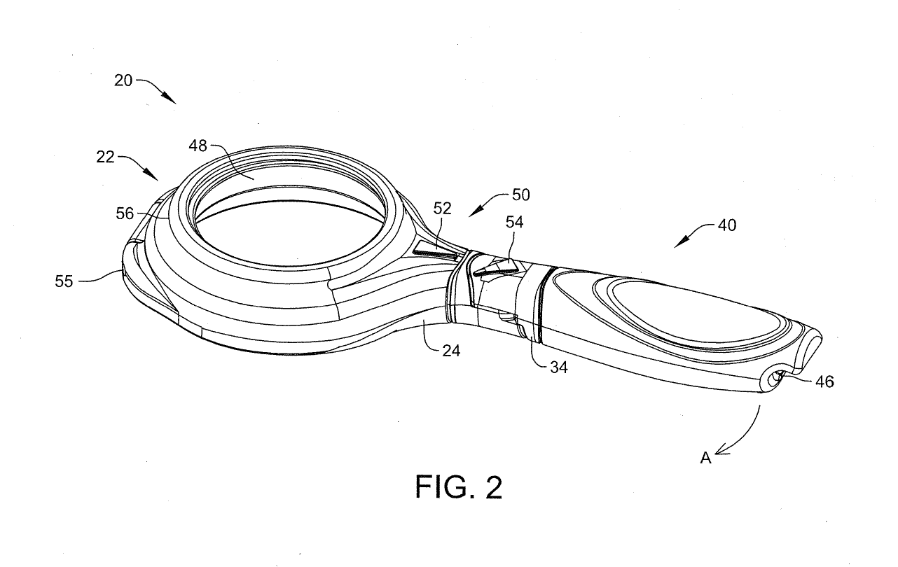

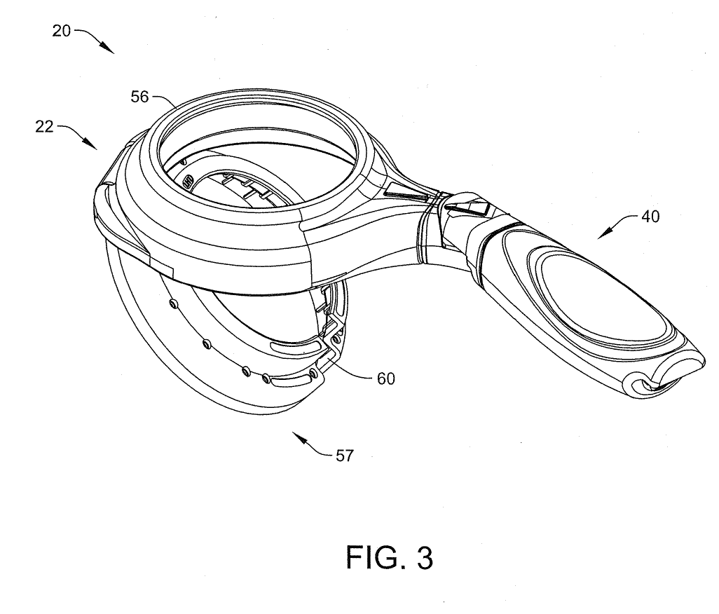

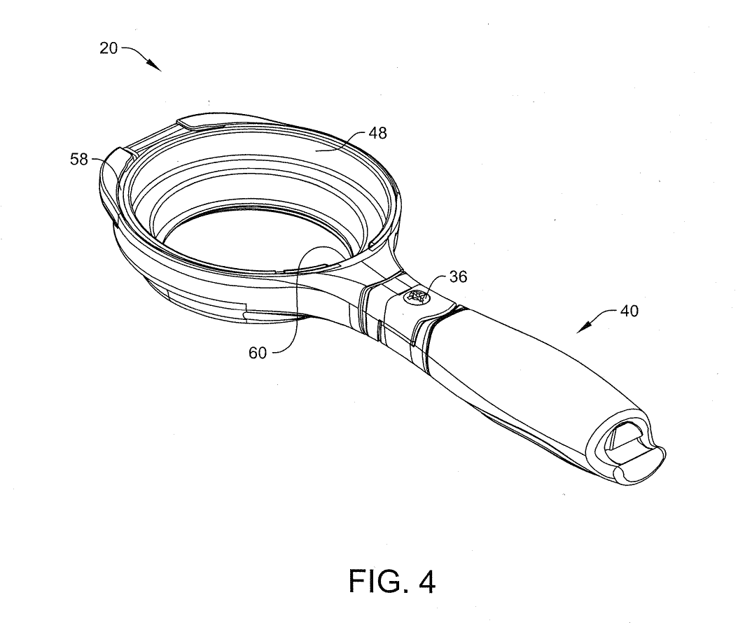

FIG. 1 is a perspective exploded view of an example canning jar band tool 20 according to a first embodiment of the present disclosure. FIG. 2 is a top perspective view of canning jar band tool 20, and FIG. 3 is a further top perspective view of band tool 20, shown in a partially deployed orientation. FIG. 4 is a bottom perspective view of canning jar band tool 20. Band tool 20 includes a head assembly 22 including a tool head 56 coupled to a head frame 24. In the example embodiment, tool head 56 is fabricated from ABS plastic, although in alternative embodiments, any other material may be used that enables band tool 20 to function as described herein. Head frame 24 is fabricated from aluminum, or any other material that enables band tool 20 to function as described herein. In the example embodiment, tool head 56 is a multipiece (not shown) component that is assembled around head frame 24. In an alternative embodiment, tool head 56 is molded onto head frame 24. In still further alternative embodiments, tool head 56 is coupled to head frame 24 using any coupling method that enables tool 20 to function as described herein.

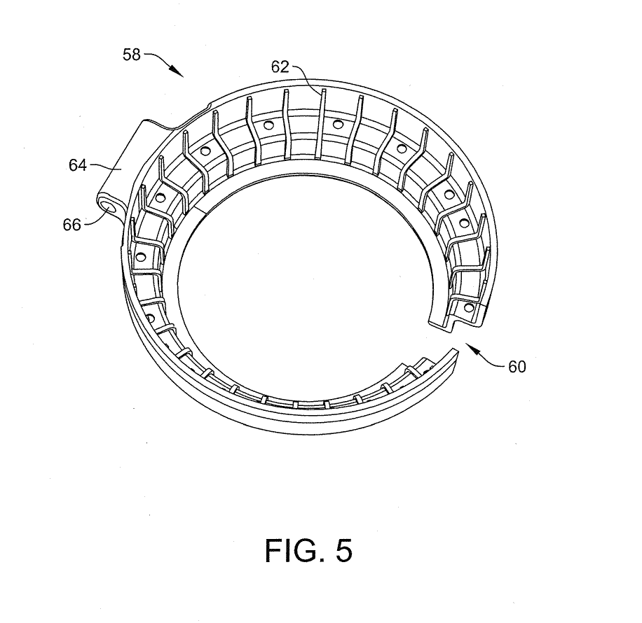

Tool head 56 is pivotably coupled to a split band compression ring 57 (shown in FIG. 3). As shown in FIG. 1, a circumferential gap 60 is provided in split band compression ring 57 to allow for radial compression and clamping around a jar lid. Split band compression ring 57 includes a band compression ring frame 58 (shown in FIGS. 4 and 5) and a compression ring overmold 48 (shown in FIGS. 2 and 4). In the example embodiment, band compression ring frame 58 is fabricated from ABS plastic. In alternative embodiments, band compression ring frame 58 is fabricated from any suitable material that enables band tool 20 to function as described herein. Compression ring overmold 48 (shown in FIG. 2) is securely coupled to band compression ring frame 58. In the example embodiment, overmold 48 is fabricated from a flexible resilient material, such as rubber or silicone, and is chemically and/or mechanically coupled to band compression ring frame 58 using any suitable fastening method that securely couples overmold 48 to band compression ring frame 58, such as via insert molding.

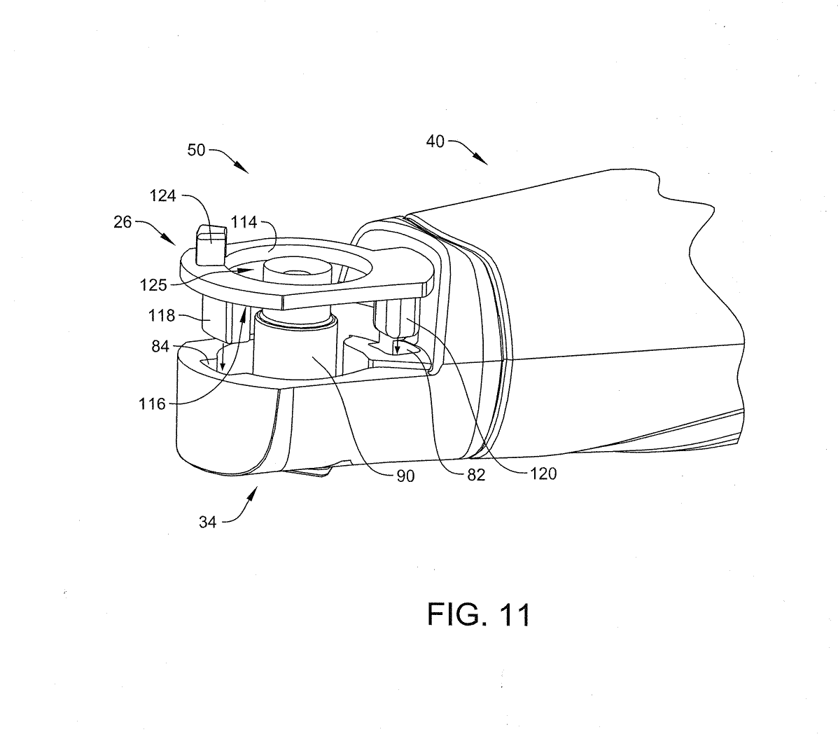

Head frame 24 is coupled to a handle frame 30 via a torsion limit assembly 50 (shown in FIG. 11) that includes a pivot angle limit insert 26 and a coil spring 28 (shown in FIG. 1). Torsion limit assembly 50 further includes a head frame insert receiver 32 on head frame 24, and a handle frame insert receiver 34 on handle frame 30. Pivot angle limit insert 26 and coil spring 28 are inserted into and between head frame insert receiver 32 and handle frame insert receiver 34. A fastener 36 facilitates coupling of head frame 24 to handle frame 30. In the example embodiment, pivot angle limit insert 26 enables limited pivoting movement of handle frame 30 relative to head frame 24, as described hereinbelow.

In the example embodiment, handle frame 30 is fabricated from aluminum, although in alternative embodiments, any other material may be used that enables band tool 20 to function as described herein. A handle boot 38 is positioned on handle frame 30. In the example embodiment, handle boot 38 is fabricated from any suitable resilient and flexible material, such as thermoplastic rubber or silicone, to provide a resilient gripping surface and to facilitate sliding handle boot 38 onto handle frame 30.

Handle frame 30 and handle boot 38 collectively form a handle assembly 40 (shown in FIG. 2). Torsion limit assembly 50 (shown in FIG. 11) facilitates resistive pivoting of handle assembly 40 relative to head assembly 22, as described hereinbelow. Torsion limit assembly 50 also includes an indicator 52 on tool head 56, and an indicator 54 on handle frame insert receiver 34. In the example embodiment, indicators 52 and 54 are arrowhead-shaped. Indicators 52 and 54 are positioned on head frame 24 and handle frame 30, respectively, such that when handle assembly 40 is oriented relative to head assembly 22 as illustrated in FIG. 2, indicators 52 and 54 point away from one another. When handle assembly 40 is pivoted relative to head assembly 22, as occurs during tightening of a closure band on a jar, indicators 52 and 54 point toward each other and become aligned as illustrated in FIG. 3, and as described in further detail hereinbelow.

FIG. 5 is a bottom perspective view of band compression ring frame 58. Band compression ring frame 58 includes gap 60, a plurality of inwardly-projecting ribs 62, and a hinge tab 64. A bore 66 facilitates the pivotable coupling of band compression ring frame 58 to tool head 56 with a pin 59 (shown in FIG. 1) extending through bore 66 and into aligned bores 55 (shown in FIGS. 1 and 2) formed in tool head 56.

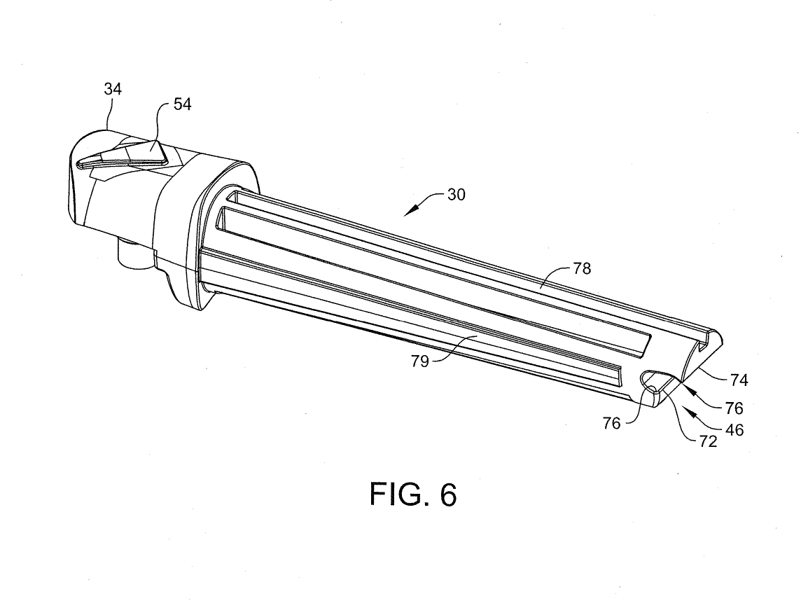

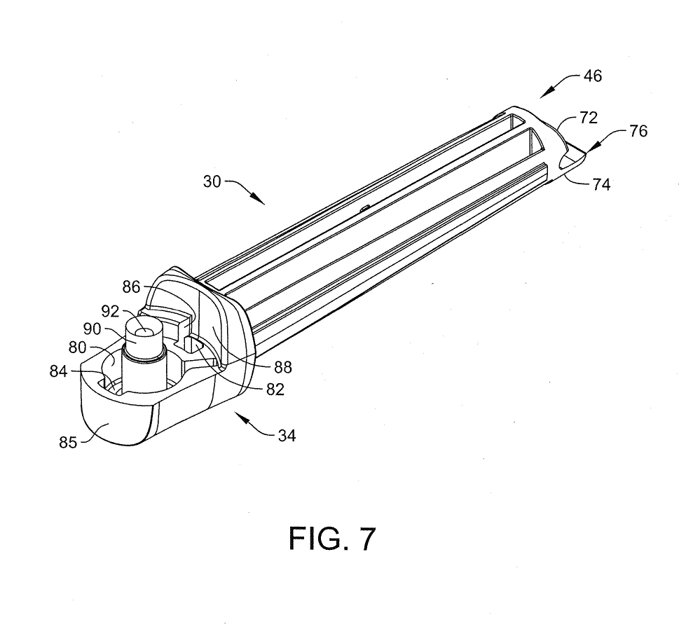

FIG. 6 is an enlarged top perspective view of handle frame 30, and FIG. 7 is an enlarged bottom perspective view of handle frame 30. In the example embodiment, handle frame 30 includes handle frame insert receiver 34, and a rear end portion 46 configured to facilitate removal of a lid, as described in further detail hereinafter. End portion 46 includes a lower jaw 72 and an upper jaw 74 that includes sharp corners 76. Handle frame 30 further includes at least one longitudinally extending slot 78, and at least one longitudinally-extending rib 79. Handle frame insert receiver 34 includes an annular recess 80, a first pocket 82, a second pocket 84, a curved front wall 85, a shoulder 86, and a curved rear wall 88. A fastener receiver 90 extends outwardly from recess 80 and includes a fastener-receiving bore 92. In the example embodiment, bore 92 is internally-threaded for engagement with fastener 36 (shown in FIG. 1).

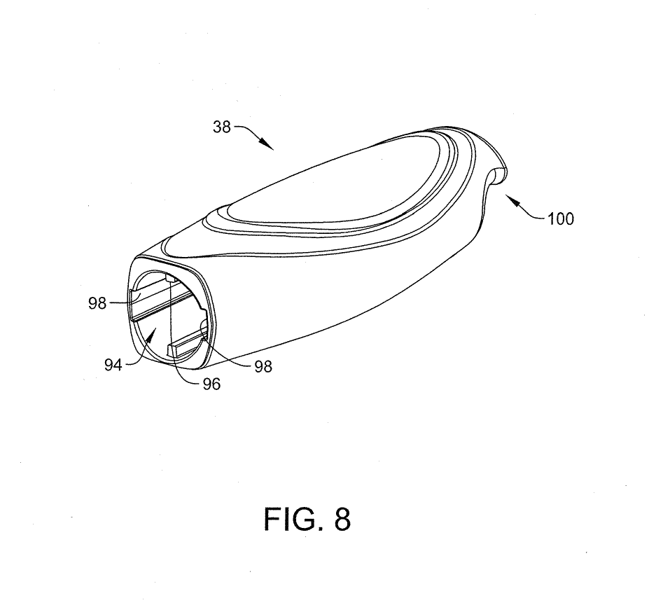

FIG. 8 is a front perspective view of handle boot 38. Handle boot 38 includes a longitudinally-extending bore 94. In the example embodiment, bore 94 defines at least one longitudinally-extending rib 96, and at least one longitudinally-extending channel 98. Handle boot 38 further includes a boot opener end 100. To assemble handle assembly 40, handle boot 38 is slid onto handle frame 30, such that a rib 96 is inserted into a slot 78 in handle frame 30, and a rib 79 from handle frame 30 is inserted into a corresponding channel 98.

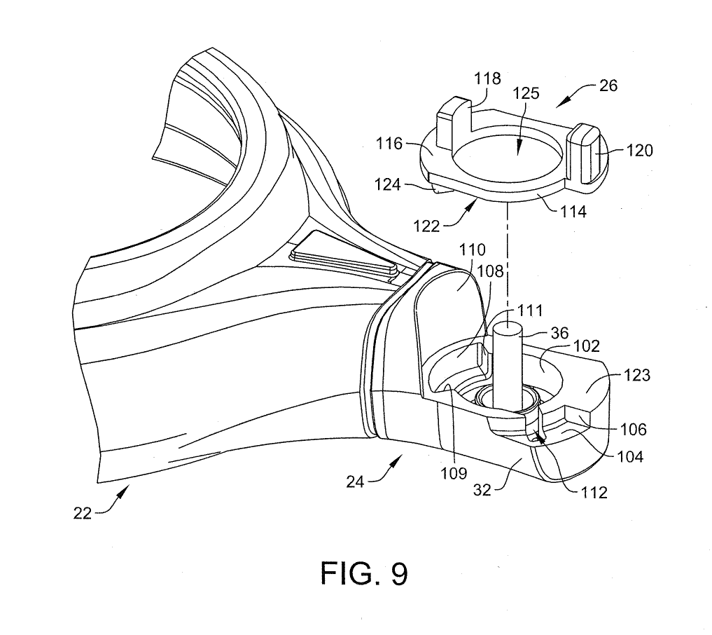

FIGS. 9-11 illustrate cooperation of the components that collectively define torsion limit assembly 50 (shown in FIGS. 2 and 11). As shown in FIG. 9, head frame insert receiver 32 includes a recess 102, a front notch 104 including a shoulder 106, a curved rear recess 108, and a curved rear wall 110. A channel 112 extends from recess 102 toward or into front notch 104. Following placement of insert 26 on head frame insert receiver 32, a downwardly-projecting post 124 extends from a lower surface 122 of a ring portion 114 of insert 26 into recess 108. Lower surface 122 is oriented against an upper surface 123 of head frame insert receiver 32. Insert 26 further includes a first post 118 and a second post 120, both extending from an upper surface 116. Insert 26 further includes a central aperture 125 through which fastener 36 projects. In the example embodiment, recess 108 is arcuate and is larger than post 124, such that when insert 26 is pivoted relative to head frame insert receiver 32, movement of post 124 from a position proximate a first end wall 109 to a position proximate a second end wall 111 is facilitated.

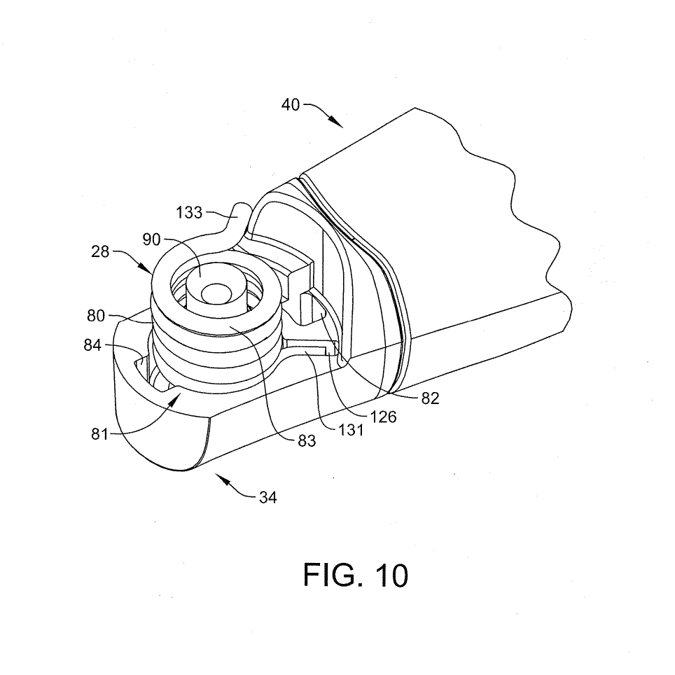

FIG. 10 illustrates components of torsion limit assembly 50 associated with handle assembly 40. A first or lower body portion 81 of coil spring 28 is received in recess 80 of handle frame insert receiver 34, and a first tail end 131 of coil spring 28 is captured within a notch 126 extending from recess 80. A second or upper body portion 83 of coil spring 28 is received in recess 102 of head frame insert receiver 32, and a second tail end 133 of coil spring 28 is received within channel 112 (shown in FIG. 9), when handle assembly 40 is coupled to head assembly 22.

FIG. 11 illustrates cooperation of insert 26 with handle frame insert receiver 34. Coil spring 28 is omitted from FIG. 11 for clarity of illustration. Post 118 is received by pocket 84. Post 120 is received by pocket 82. In the example embodiment, posts 118 and 120 and corresponding pockets 84 and 82 are sized such that movement of insert 26 relative to handle frame insert receiver 34 is substantially precluded. Fastener receiver 90 extends through aperture 125.

Following assembly of handle assembly 40 to head assembly 22, canning jar band tool 20 is left in an “at rest” orientation as shown in FIG. 2. Posts 118, 120, and 124 of insert 26 cooperate with pockets 84 and 82 of handle frame insert receiver 34, and curved rear recess 108 of head frame insert receiver 32, to enable pivoting of handle assembly 40 in the direction of arrow A (shown in FIG. 2) from the “at rest” orientation, against resistive force exerted by coil spring 28. Moreover, pivoting of handle assembly 40 in a direction opposite to arrow A from the “at rest” orientation is substantially precluded. In the example embodiment, coil spring 28, particularly tail ends 131 and 133, and the corresponding notches 126 and 112 that capture tail ends 131 and 133, are oriented such that coil spring 28 is in a neutral state. Alternatively, coil spring 28 is preloaded with a small amount of tension or compression (depending on how coil spring 28 is wound), such that coil spring 28 exerts a small amount of force prompting canning jar band tool 20 to remain in the at rest orientation shown in FIG. 2.

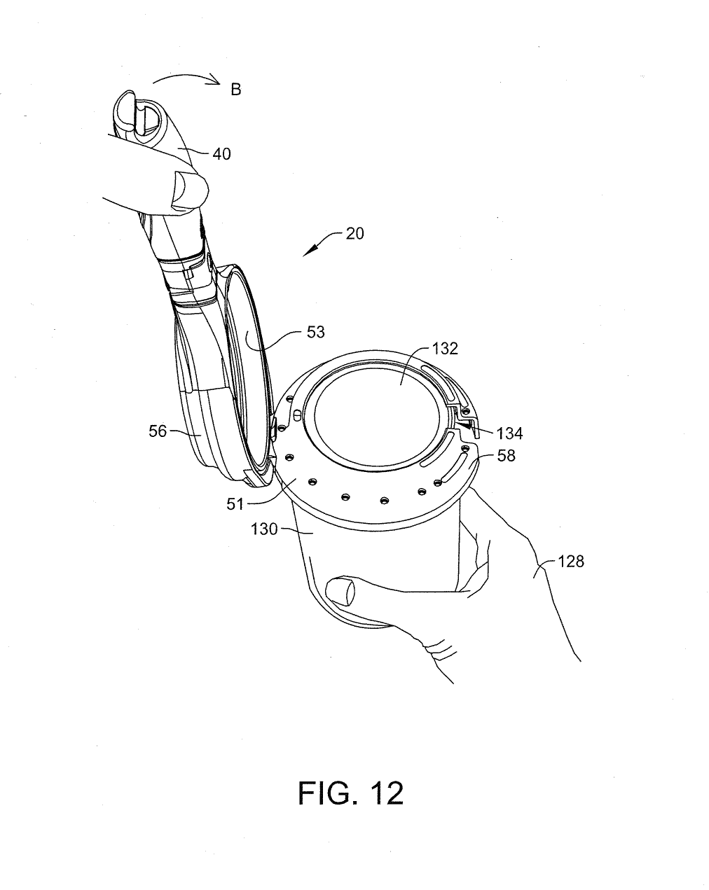

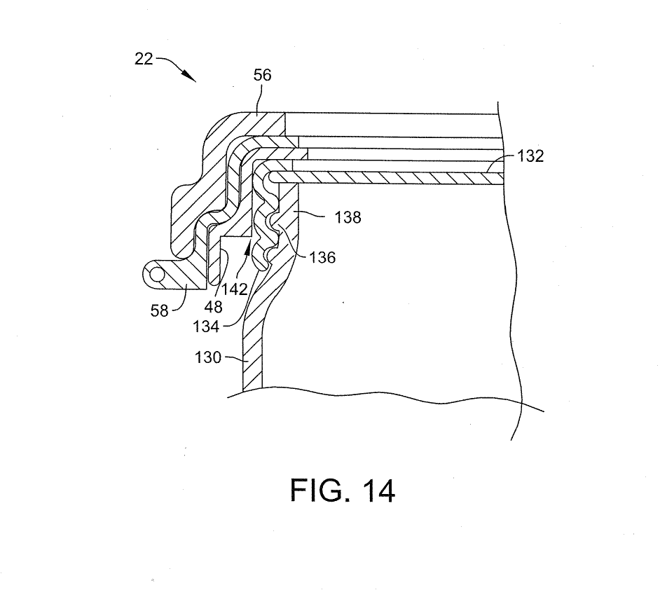

FIGS. 12-14 illustrate a method of use of canning jar band tool 20 on a canning jar 130. A disc-shaped lid 132 is positioned on canning jar 130, and an annular canning jar closure band 134 is screwed onto jar 130 over lid 132, such that jar closure band 134 at least partially engages threads 136 on a jar neck 138 (both shown in FIG. 14). A user 128 pivots band compression ring frame 58 away from tool head 56 and positions band compression ring frame 58 over closure band 134. As illustrated in FIG. 14, both band compression ring frame 58 and overmold 48 (which provides a resilient gripping surface inside band compression ring frame 58) include at least one step 142 to allow band compression ring frame 58 and overmold 48 to accommodate closure bands 134 of at least two different diameters. In the example embodiment, step 142 accommodates closure bands 134 having diameters of 70 mm and 86 mm, which correspond to typical home canning jar closure band sizes.

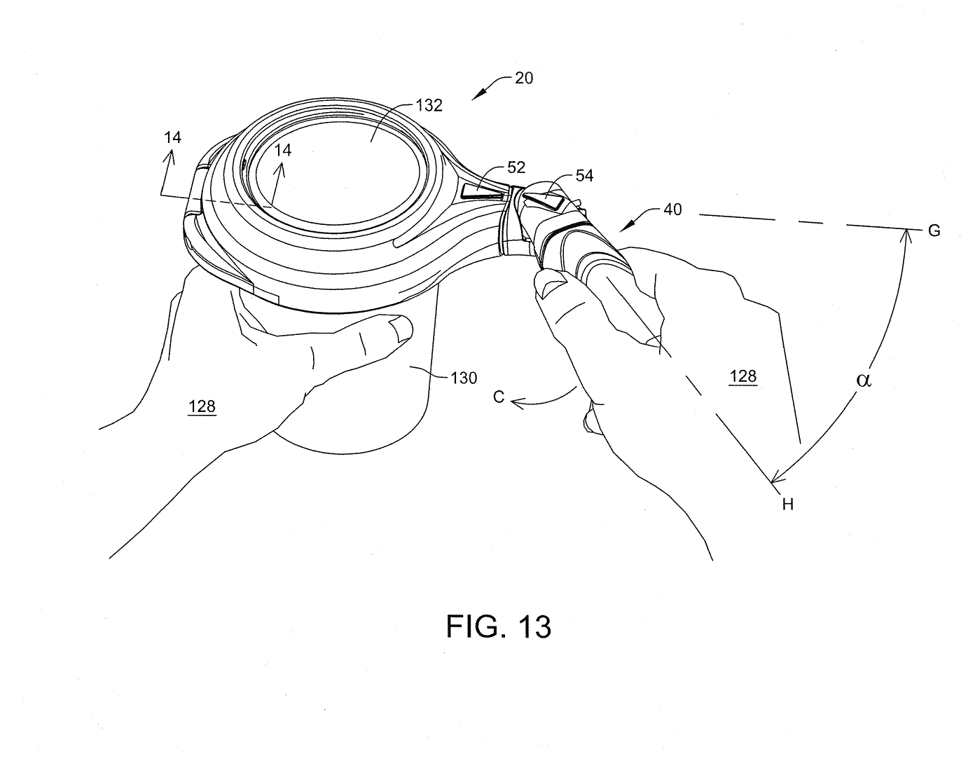

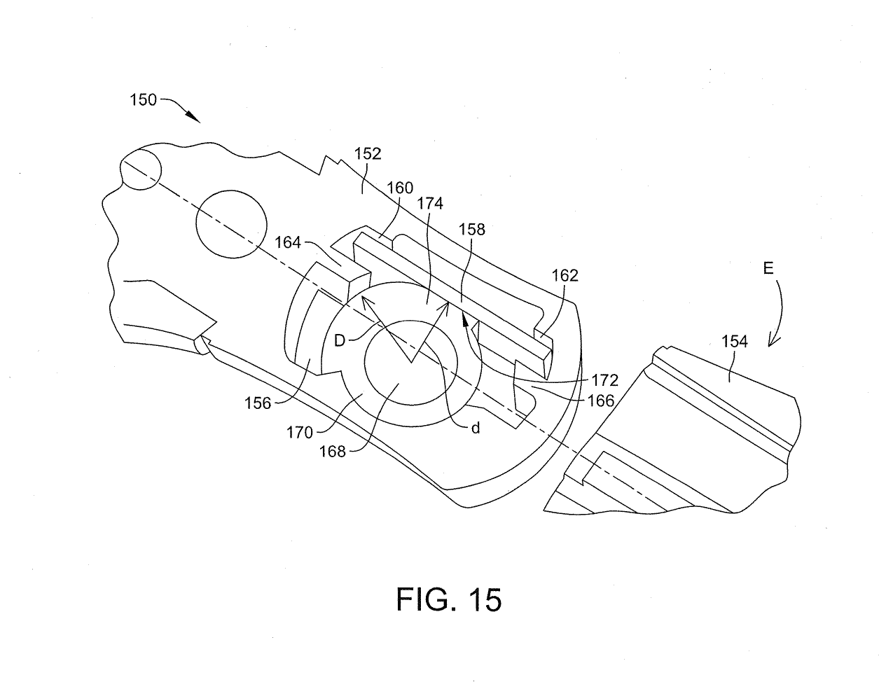

In the example embodiment, band compression ring frame 58 and overmold 48 are configured to rest loosely over closure band 134. User 128 pivots handle assembly 40 downwardly in the direction of arrow B (shown in FIG. 12). As shown in FIGS. 12 and 15, an exterior surface portion 51 of band compression ring frame 58 and an interior surface portion 53 of tool head 56 are each provided with a radially stepped, generally frusto-conical configuration to enable them to be nested, as shown in FIG. 14. A slight amount of downward pressure is required to force overmold 48 to radially compress and to circumferentially close gap 60 a sufficient amount to enable user 128 to force tool head 56 down over band compression ring frame 58 and into the position shown in FIG. 13. User 128 then applies a twisting force in the direction of arrow C to further tighten closure band 134 onto jar 130. As closure band 134 approaches a desired degree of tightness on jar 130, user 128 encounters progressively increased resistance. In the example embodiment, coil spring 28 is configured to have a predetermined spring force that is approximately equal to a desired amount of torque to be applied to closure band 134 when the arrow indicators 52 and 54 are substantially linearly aligned as shown in FIG. 13. In the example embodiment, the desired final tightening torque level is 25 in.-lbs.±5 in.-lbs., which is a range of torque desired for effective sealing of typical home canning jar closures. In alternative embodiments, coil spring 28 is configured with any level of spring force that enables band tool 20 to function as described herein.

After user 128 has tightened closure band 134 to the desired amount of tightness, if user 128 continues to apply twisting force in excess of the predetermined spring force of coil spring 28, coil spring 28 yields, further enabling handle assembly 40 to pivot in the direction of arrow C until post 124 abuts second end wall 111. Indicators 52 and 54 align, indicating that closure band 134 has been sufficiently tightened. In the example embodiment of FIG. 13, torsion limit assembly 50 enables handle assembly 40 to be pivoted an angle α between a centerline G of head assembly 22 and a centerline H of handle assembly 40, wherein a is about 60°. In alternative embodiments, a is any angle that enables band tool 20 to function as described herein.

In addition to facilitating tightening of closure band 134 onto a jar 130, user 128 can use canning jar band tool 20 to remove a closure band 134. User 128 positions tool 20 onto a sealed jar 130, and applies twisting force in a direction opposite to arrow C. Leverage provided by tool 20 results in less force required to be exerted by user 128.

FIG. 15 is a sectional exploded perspective view of a pivot angle limit assembly 150 that may be used in canning jar band tool 20, according to an alternative example embodiment of the disclosure. A head frame 152 includes a recess 156, which receives a spring bar 158. Spring bar 158 is captured between a shoulder 160 and a shoulder 162 on one side, and walls 164 and 166 on an opposite side. A rotary cam 170 encircles a post 168 and is oriented such that in an “at rest” orientation (shown in FIG. 15), a surface 172, representing a first diameter d of cam 170 is juxtaposed against spring bar 158. In one embodiment, cam 170 is coupled, or coupleable, to a handle frame 154. Accordingly, after head frame 152 is coupled to handle frame 154, twisting force exerted on handle frame 154 relative to head frame 152, in the direction of arrow E, causes cam 170 to rotate within recess 156. The transition to a radially thicker portion 174 of cam 170, having a second radius D that is greater than first radius d, causes cam 170 to push against spring bar 158, creating increased resistance to pivoting, until portion 174 is fully in contact with spring bar 158. Thereafter, portion 174 has a substantially constant radius. Accordingly, the torque required for continued pivoting of handle frame 154 relative to head frame 152 plateaus at a constant value.

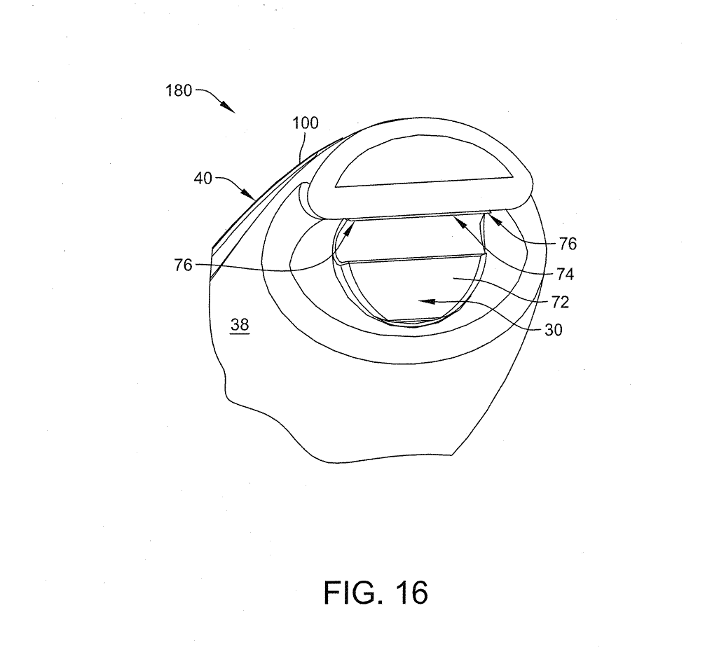

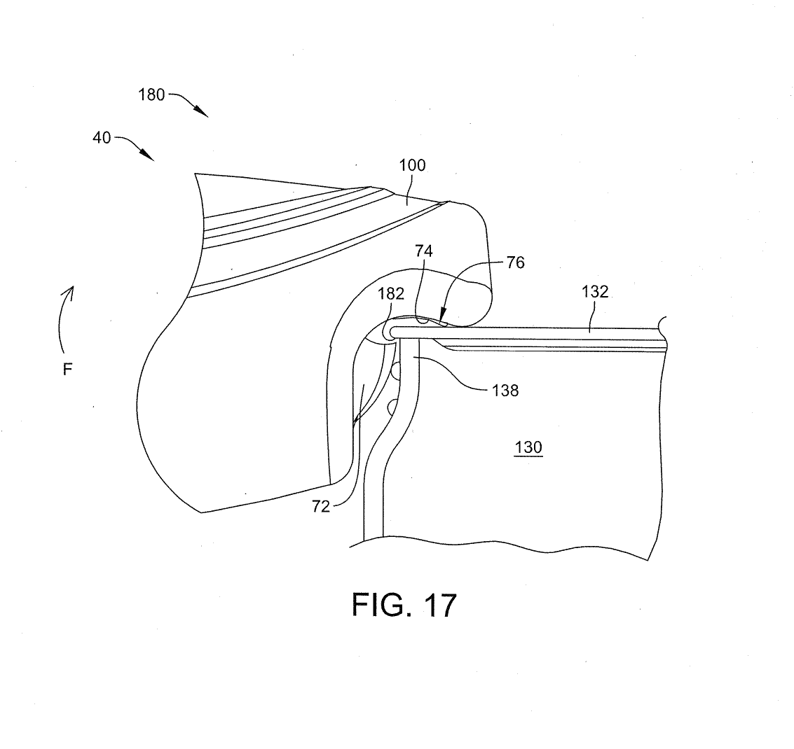

FIGS. 16 and 17 illustrate another aspect of the present disclosure for facilitating opening of sealed canning jars 130. A jar opener system 180 of handle assembly 40 includes boot opener end 100. Opener system 180 further includes lower jaw 72 and upper jaw 74 of handle frame 30. Upper jaw 74 includes sharp corners 76.

After a user has removed a closure band (not shown in FIGS. 16 and 17) as described above, the user positions opener system 180 onto an edge 182 of a lid 132. The user pivots handle assembly 40 in the direction of arrow F, causing lower jaw 72 to pry edge 182 of lid 132 upwardly off of jar 130. In so doing, upper jaw 74 is forced downwardly onto lid 132. Boot opener end 100 is pushed upwardly relative to upper jaw 74 by lid 132, exposing corners 76. Upper jaw 74 generally, and corners 76 in particular, crush a portion of edge 182, rendering lid 132 unsuitable for re-use, in accordance with typical recommendations of canning jar manufacturers.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. While the disclosure has been described in terms of various specific embodiments, it will be recognized that the disclosure can be practiced with modification within the spirit and scope of the claims.

What is claimed is:

1. A canning closure tool for facilitating manipulation of a closure for a canning jar, wherein the closure includes a lid and an annular screw-threaded closure band, said canning closure tool comprising:
a head assembly for releasably gripping a closure band;
a handle assembly; and
a torsion limit assembly coupling said head assembly to said handle assembly, said torsion limit assembly configured to facilitate selective pivoting movement of said handle assembly relative to said head assembly.

2. A canning closure tool in accordance with claim 1, wherein said torsion limit assembly further comprises:
a head frame insert receiver coupled to said head assembly; and
a handle frame insert receiver coupled to said handle assembly, wherein said head frame insert receiver and said handle frame insert receiver are pivotably coupled to each other.

3. A canning closure tool in accordance with claim 2, wherein said torsion limit assembly comprises a resilient member configured to retain said handle assembly in a fixed orientation relative to said head assembly and transmit a pivoting force applied to said handle assembly through said torsion limit assembly to said head assembly, said resilient member further configured to enable said handle assembly to pivot relative to said head assembly when the applied pivoting force exceeds a predetermined value.

4. A canning closure tool in accordance with claim 3, wherein said resilient member comprises a coil spring member interposed between said head frame insert receiver and said handle frame insert receiver, wherein said coil spring member includes a first tail end coupled to said head frame insert receiver and a second tail end coupled to said handle frame insert receiver.

5. A canning closure tool in accordance with claim 2, wherein said torsion limit assembly comprises at least one pivot limit member configured to limit pivoting movement of said handle assembly relative to said head assembly to a predetermined maximum amount.

6. A canning closure tool in accordance with claim 5, wherein said at least one pivot limit member comprises an insert member interposed between said head frame insert receiver and said handle frame insert receiver,
wherein said insert member includes at least one first post coupled to one of said head frame insert receiver and said handle frame insert receiver for securing said insert member against movement relative to said one of said head frame insert receiver and said handle frame insert receiver, and
wherein said insert member includes at least one second post coupled to the other of said head frame insert receiver and said handle frame insert receiver for enabling relative pivoting movement of said insert receiver relative to said other of said head frame insert receiver and said handle frame insert receiver.

7. A canning closure tool in accordance with claim 1, wherein said torsion limit assembly further comprises:
a first indicator located on said head assembly; and
a second indicator located on said handle assembly, wherein said first and second indicators are aligned when said handle assembly is pivoted to a predetermined maximum amount relative to said head assembly.

8. A canning closure tool in accordance with claim 1, wherein said handle assembly comprises:
a handle frame; and
a resilient handle boot surrounding said handle frame for facilitating gripping of said canning closure tool.

9. A canning closure tool in accordance with claim 8, wherein said handle assembly further comprises a lid removal assembly.

10. A canning closure tool in accordance with claim 9, wherein said lid removal assembly comprises:
an upper jaw extending from an end of said handle frame;
a lower jaw extending from said end of said handle frame and spaced a distance from said upper jaw, wherein said upper and lower jaws are configured to grip between them an edge of a lid positioned on a canning jar, and lift the lid from the jar upon pivoting of the handle assembly relative to the canning jar; and
an end portion of said handle boot movable between a position covering said upper jaw to a position displaced from said upper jaw upon pivoting of the handle assembly relative to the canning jar.

11. A canning closure tool for facilitating manipulation of a closure for a canning jar, wherein the closure includes a lid and an annular screw-threaded closure band, said canning closure tool comprising:
a handle assembly; and
a head assembly coupled to said handle assembly for releasably gripping a closure band, wherein said head assembly includes:
a head tool coupled to said handle assembly, and
a split band compression ring pivotably coupled to said head tool for pivoting between a nested position within said head tool and a deployed position for facilitating positioning of said band compression ring frame around a canning jar closure band.

12. A canning closure tool in accordance with claim 11, wherein said split band compression ring comprises:
a band compression ring frame; and
an inner resilient overmold layer coupled to said band compression ring frame.

13. A canning closure tool in accordance with claim 11, wherein said split band compression ring comprises at least one step for enabling said split band compression ring to grip at least two sizes of closure bands.

14. A canning closure tool in accordance with claim 11, wherein said head assembly further comprises a head frame coupled to said tool head.

15. A method for assembling a canning closure tool for facilitating manipulation of a closure for a canning jar, wherein the closure includes a lid and an annular screw-threaded closure band, said method comprising:
providing a head assembly for releasably gripping a closure band;
providing a handle assembly; and
coupling the head assembly to the handle assembly with a torsion limit assembly, wherein the torsion limit assembly is configured to facilitate selective pivoting movement of said handle assembly relative to the head assembly.

16. A method in accordance with claim 15, wherein coupling the head assembly to the handle assembly with a torsion limit assembly comprises:
coupling a head frame insert receiver to the head assembly;
coupling a handle frame insert receiver to the handle assembly; and
pivotably coupling the head frame insert receiver to the handle frame insert receiver.

17. A method in accordance with claim 16, said method further comprising coupling a resilient member between the head frame insert receiver and the handle frame insert receiver for retaining the handle assembly in a fixed orientation relative to the head assembly and transmitting a pivoting force applied to the handle assembly through the torsion limit assembly to the head assembly, wherein the resilient member is further configured to enable the handle assembly to pivot relative to the head assembly when the applied pivoting force exceeds a predetermined value.

18. A method in accordance with claim 16, wherein the resilient member comprises a coil spring member interposed between the head frame insert receiver and the handle frame insert receiver, and further wherein the coil spring member includes a first tail end coupled to the head frame insert receiver and a second tail end coupled to the handle frame insert receiver.

19. A method in accordance with claim 16, wherein coupling the head assembly to the handle assembly with a torsion limit assembly further comprises coupling at least one pivot limit member to the head frame insert receiver and the handle frame insert receiver to limit pivoting movement of the handle assembly relative to the head assembly to a predetermined maximum amount.

20. A method in accordance with claim 16, wherein coupling at least one pivot member to the head frame insert receiver and the handle frame insert receiver comprises interposing an insert member between the head frame insert receiver and the aid handle frame insert receiver,
wherein the insert member includes at least one first post coupled to one of the head frame insert receiver and the handle frame insert receiver for securing the insert member against movement relative to the one of the head frame insert receiver and the handle frame insert receiver, and
wherein the insert member includes at least one second post coupled to the other of the head frame insert receiver and the handle frame insert receiver for enabling relative pivoting movement of the insert receiver relative to the other of the head frame insert receiver and the handle frame insert receiver.
